(19) United States
(12) Patent Application Publication
(10) Pub. No.: US 2016/0110427 A1
(43) Pub. Date: Apr. 21, 2016

(54) APPARATUS, SYSTEM, AND METHOD FOR ORGANIZING AND EMBEDDING APPLICATIONS

(71) Applicant: Yttro Mobile Inc., Sunnyvale, CA (US)

(72) Inventor: Xiaoxu MA, Sunnyvale, CA (US)

(73) Assignee: YTTRO MOBILE INC.

(21) Appl. No.: 14/919,069

(22) Filed: Oct. 21, 2015

Related U.S. Application Data
(60) Provisional application No. 62/066,723, filed on Oct. 21, 2014.

(51) Int. Cl. G06F 17/30; G06F 3/0484

(52) U.S. Cl. CPC G06F 17/30528; G06F 3/04847; G06F 3/04842

(57) ABSTRACT

The present disclosure relates to methods and systems for organizing mobile applications. An exemplary method may include receiving information associated with a plurality of mobile applications and computing a distance function indicating similarities of the plurality of mobile applications. The method may also include grouping the plurality of mobile applications based on the distance function. Another exemplary method may include displaying a plurality of mobile application in a two-dimensional grid and detecting an input signal indicating user behavior in connection to the two-dimensional grid. Based on the input signal, the method may include determining a mobile application to be inserted into the two-dimensional grid and displaying the inserted mobile application in the two-dimensional grid. Another exemplary method may include determining a distance between two clusters of mobile applications based on their similarities and embedding the two clusters into a two-dimensional grid based on the distance.

### CROSS-REFERENCE TO RELATED APPLICATION

The present application claims the benefit of priority to U.S. Provisional Application No. 62/066,723, filed Oct. 21, 2014, the entire contents of which are incorporated herein by reference.

### TECHNICAL FIELD

This disclosure relates generally to organizing applications on a computer. More specifically, it relates to organizing and embedding applications into a two-dimensional grid view based on similarities of the applications.

### BACKGROUND

Mobile devices, such as smartphones and tablets, are becoming more and more versatile, thanks to the variety of mobile applications that extend the functionalities of the mobile devices well beyond voice calling and messaging. For example, a user may use his/her mobile device to play games, read newspaper/books/magazines, check/send emails, organize daily activities, watch movies, listen to music, track health-related information, order meals, pay bills, etc.

A mobile device may achieve a particular function through running a mobile application. A user may obtain a mobile application through, for example, downloading the mobile application from a mobile application store—an online software store that provides various mobile applications for downloading free of charge or for a fee. For example, a mobile application store may be a mobile application by itself executable on the user's mobile device, through which the user may browse or explore one or more mobile applications, usually organized by category (game, business, education, etc.), ranking (top 10, top 50, etc.), free or paid, etc.

Mobile application stores may have a function of recommending mobile applications to a user. For example, once the user selects or downloads a mobile application, one or more related mobile applications may be provided to the user through a listing, normally formatted in a row or a column, of the representing images of these related mobile applications. However, the mobile application recommendation functions provided by current mobile application stores have several shortcomings. First, the recommended mobile applications normally have a low degree of relevance to the mobile application selected by the user. Second, the recommended mobile applications are normally provided to the user with a limited field of view (e.g., the recommended mobile applications are arranged in a single eight-slot row or on a five-slot list per page). As a result, a user may feel reluctant to further explore similar mobile applications.

Therefore, it is desirable to develop a solution capable of generating highly relevant mobile applications based on a user's interest and recommending the mobile applications to the user in an intuitive and convenient way.

### SUMMARY

Certain embodiments of the present disclosure relate to a method, implemented by a processor device, for grouping mobile applications. The method may comprise receiving information associated with a plurality of mobile applications. The method may also comprise computing a distance function indicating similarities of the plurality of mobile applications. In addition, the method may comprise grouping the plurality of mobile applications based on the distance function.

Certain embodiments of the present disclosure also relate to a computer system for grouping mobile applications. The system may comprise a processor device operatively coupled to a memory device. The processor device may be configured to execute instructions stored in the memory device to perform operations. The operations may comprise receiving information associated with a plurality of mobile applications. The operations may also comprise computing a distance function indicating similarities of the plurality of mobile applications. In addition, the operations may comprise grouping the plurality of mobile applications based on the distance function.

Certain embodiments of the present disclosure also relate to a non-transitory, computer-readable medium storing instructions that, when executed by a processor device, cause the processor device to perform operations. The operations may comprise receiving information associated with a plurality of mobile applications. The operations may also comprise computing a distance function indicating similarities of the plurality of mobile applications. In addition, the operations may comprise grouping the plurality of mobile applications based on the distance function.

Certain embodiments of the present disclosure relate to a method, implemented by a processor device, for organizing mobile applications. The method may comprise controlling a display device to display a plurality of mobile applications in a two-dimensional grid and detecting, using an input device, an input signal indicating user behavior in connection to the two-dimensional grid. The method may also comprise determining a mobile application to be inserted into the two-dimensional grid based on the detected input signal. In addition, the method may comprise controlling the display device to display the inserted mobile application in the two-dimensional grid.

Certain embodiments of the present disclosure also relate to a computer system for organizing mobile applications. The system may comprise a processor device operatively coupled to a memory device. The processor device may be configured to execute instructions stored in the memory device to perform operations. The operations may comprise controlling a display device to display a plurality of mobile applications in a two-dimensional grid and detecting, using an input device, an input signal indicating user behavior in connection to the two-dimensional grid. The operations may also comprise determining a mobile application to be inserted into the two-dimensional grid based on the detected input signal. In addition, the operations may comprise controlling the display device to display the inserted mobile application in the two-dimensional grid.

Certain embodiments of the present disclosure also relate to a non-transitory, computer-readable medium storing instructions that, when executed by a processor device, cause the processor device to perform operations. The operations may comprise controlling a display device to display a plurality of mobile applications in a two-dimensional grid and detecting, using an input device, an input signal indicating user behavior in connection to the two-dimensional grid. The operations may also comprise determining a mobile application to be inserted into the two-dimensional grid based on the detected input signal. In addition, the operations may comprise controlling the display device to display the inserted mobile application in the two-dimensional grid.

Certain embodiments of the present disclosure relate to a method, implemented by a processor device, for embedding mobile applications into a two-dimensional grid. The method may comprise receiving first and second clusters of mobile applications. The method may also comprise determining a distance between the first and second clusters based on similarities between the first and second clusters. In addition, the method may comprise embedding the first and second clusters into the two-dimensional grid based on the distance.

Certain embodiments of the present disclosure also relate to a computer system for embedding mobile applications into a two-dimensional grid. The system may comprise a processor device operatively coupled to a memory device. The processor device may be configured to execute instructions stored in the memory device to perform operations. The operations may comprise receiving first and second clusters of mobile applications. The operations may also comprise determining a distance between the first and second clusters based on similarities between the first and second clusters. In addition, the operations may comprise embedding the first and second clusters into the two-dimensional grid based on the distance.

Certain embodiments of the present disclosure also relate to a non-transitory, computer-readable medium storing instructions that, when executed by a processor device, cause the processor device to perform operations. The operations may comprise receiving first and second clusters of mobile applications. The operations may also comprise determining a distance between the first and second clusters based on similarities between the first and second clusters. In addition, the operations may comprise embedding the first and second clusters into the two-dimensional grid based on the distance.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this specification, illustrate several embodiments and, together with the description, serve to explain the disclosed principles.

FIG. 1 is a schematic diagram of an exemplary mobile application system, according to some embodiments of the present disclosure.

FIG. 2 is a schematic diagram of an exemplary mobile device, according to some embodiments of the present disclosure.

FIG. 3 is a block diagram of the exemplary mobile device shown in FIG. 2.

FIG. 4 is a schematic diagram illustrating an exemplary method for grouping mobile applications, according to some embodiments of the present disclosure.

FIG. 5 is schematic diagram illustrating an exemplary method for displaying mobile applications, according to some embodiments of the present disclosure.

FIG. 6 is a schematic diagram illustrating an exemplary method for inserting mobile applications, according to some embodiments of the present disclosure.

FIG. 7 illustrates an exemplary two-dimensional graph of grouped mobile applications, according to some embodiments of the present disclosure.

FIG. 8 is a schematic diagram illustrating an exemplary method for embedding mobile applications, according to some embodiments of the present disclosure.

FIG. 9 is a schematic diagram illustrating exemplary virtual communities, according to some embodiments of the present disclosure.

FIG. 10 is a flow chart of an exemplary method for grouping mobile applications, according to some embodiments of the present disclosure.

FIG. 11 is a flow chart of an exemplary method for inserting mobile applications, according to some embodiments of the present disclosure.

FIG. 12 is a flow chart of an exemplary method for embedding mobile applications, according to some embodiments of the present disclosure.

### DETAILED DESCRIPTION

Reference will now be made in detail to exemplary embodiments of the invention, examples of which are illustrated in the accompanying drawings. When appropriate, the same reference numbers are used throughout the drawings to refer to the same or like parts.

Embodiments consistent with the present disclosure involve mobile applications. As used herein, a mobile application may include a computer executable program. A mobile application may also be referred to as an app. In some embodiments, the term “mobile application” can include not only apps executable on smartphones or tablets, but also applications executable on laptop or desktop computers, including apps or plugins executable inside web browsers. Two mobile applications may be similar to each other when they are in the same category (e.g., both are games), have similar subject matter (e.g., both are racing games or motorcycle racing games), and/or have similar operation modes (e.g., both are racing games using acceleration sensor as an input means). Other criteria to determine similarities include game type (e.g., first person shooting, strategy, turn-by-turn, simulation, sports, etc.), developer, free/paid, price range, rating, language, operation system, resolution, etc.

Embodiments of the present disclosure may classify a collection of mobile applications into groups based on their similarities. The classified mobile applications may be arranged and displayed in a 2D grid. Similar mobile applications may be arranged together in the 2D grid to form a cluster. Different clusters may be arranged or embedded into the 2D grid based on the similarity of the clusters. Mobile applications may be inserted into a cluster based on user interest or intent detected based on user behavior. User communities or neighborhoods may be created based on user interest.

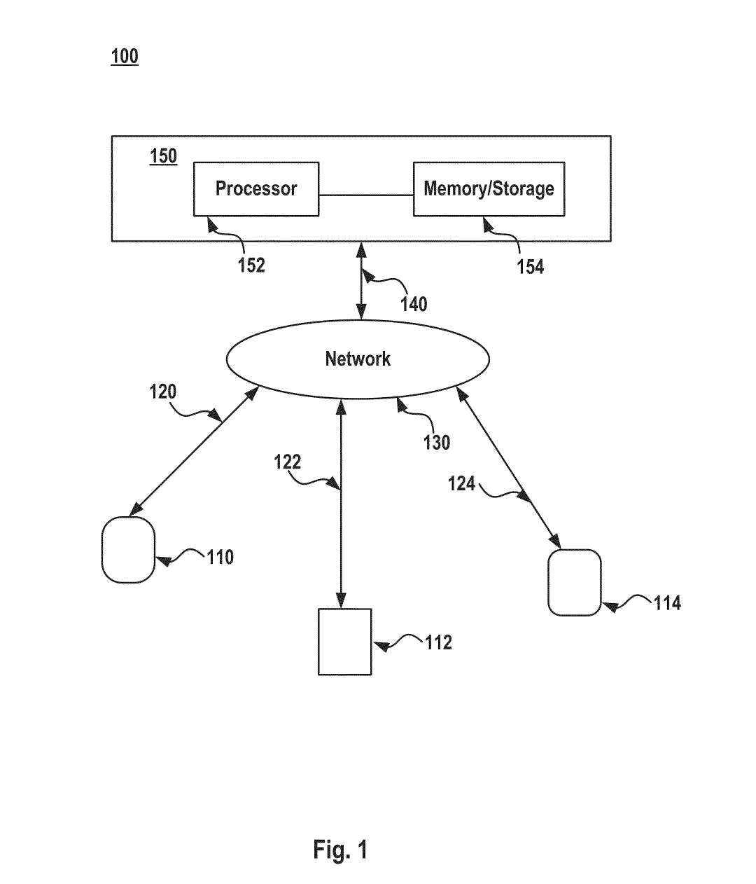

FIG. 1 is a schematic diagram of an exemplary mobile application system 100, according to some embodiments of the present disclosure. System 100 may include one or more mobile devices, such as mobile devices 110, 112, and 114. Mobile devices 110, 112, and 114 may include smartphones, tablets, personal digital assistants (PDAs), smart wearable devices such as smart watches, laptops/notebook computers, netbook computers, mobile reading devices such as e-book readers, or other mobile computing devices. As shown in FIG. 1, mobile devices 110, 112, and 114 may communicate with a network 130 via communication channels 120, 122, and 124, respectively. Network 130 may include telecommunication networks such as 3G, 4G, and LTE networks; wireless networks such as WLAN/WiFi and Bluetooth networks; the Internet; or other suitable networks capable of communicatively connecting one or more mobile devices (e.g., 110, 112, and/or 114) to a server 150. For example, in one embodiment, mobile device 110 may be a smartphone and communication channel 120 may be a telecommunication data link (e.g., 3G, 4G, LTE, etc.). In another embodiment, communication channel 120 may include a WLAN/WiFi link to a local wireless network (not shown), which in turn connects to network 130 through, for example, a broadband Internet connection such as a cable, fiber, WiMAX, or satellite network. In some embodiments, mobile device 112 may be a tablet. In some embodiments, mobile device 114 may be a laptop/notebook computer.

Server 150 may include one or more computer systems configured to receive requests from mobile devices 110, 112, and/or 114 and respond to the requests. Server 150 may connect to network 130 through a communication channel 140. Communication channel 140 may include broadband data links capable of providing high data throughputs. It is noted that although only one server and one communication channel is shown in FIG. 1, a person of ordinary skill in the art would understand that server 150 may include multiple apparatuses, computer systems, or infrastructure components that are physically located in a centralized or distributed manner, and communication channel 140 may include different types of connection technologies commensurate with the apparatuses, computer systems, or infrastructure components connected thereto.

Server 150 may include one or more processors, such as processor 152. Processor 152 may include one or more central processing units (CPUs), integrated circuits (ICs), printed circuit boards (PCBs), or other computing devices. Processor 152 can execute computer program instructions to perform various operations and/or tasks.

Server 150 may include one or more data storing devices, such as memory/storage 154. Memory/storage 154 may include a random access memory (“RAM”), a read-only memory (“ROM”), a flash drive, a solid-state drive (SSD), a hard drive, an array of high volume storage devices, or other suitable temporary or permanent data storing devices.

In some embodiments, mobile device 110 may request data or services from server 150. For example, mobile device 110 may send a request message to server 150 through communication channel 120, network 130, and communication channel 140. Server 150, upon receiving the request message, may respond to the request message by sending a response to mobile device 110. The response may include the requested data or services, or location information of the requested data or services, or other suitable information relating to the request message.

In some embodiments, mobile device 110 may download a mobile application from server 150 (e.g., from a mobile application store). The mobile application may contain data that are downloaded from server 150 and stored on mobile device 110. The data may include a collection of mobile applications (or information relating to the mobile applications such as URLs for downloading the mobile applications, introduction information, picture/video information, etc.) that are organized/grouped in a particular manner. The mobile application, when executed on mobile device 110, may communicate with server 150 (e.g., the same computer system hosting the mobile application store or a different computer system relating to the mobile application) for additional information, such as information for updating the data locally stored on mobile device 110, one or more mobile applications (or information related thereto) that are deemed similar to one another, etc.

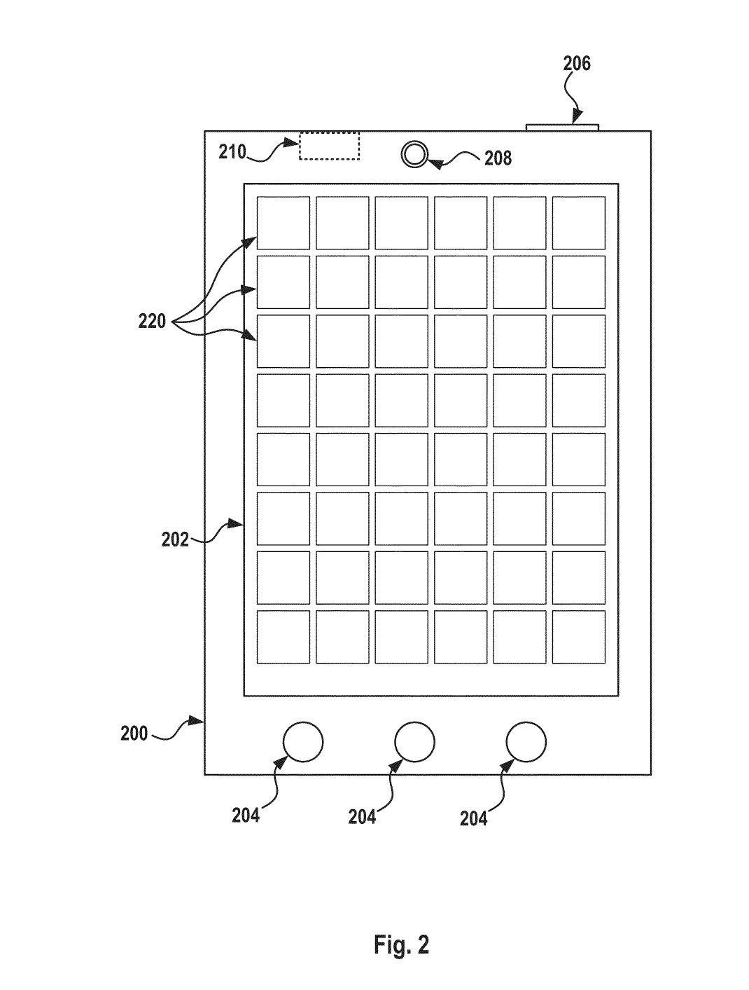

FIG. 2 is a schematic diagram of an exemplary mobile device 200, according to some embodiments of the present disclosure. Mobile device 200 shown in FIG. 2 may be an exemplary implementation of any one of mobile devices 110, 112, and 114 shown in FIG. 1. As shown in FIG. 2, mobile device 200 may include a display 202. Display 202 may include a LCD display panel, an OLED display panel, or other suitable display devices. Display 202 may be touch sensitive so that a user may input information by touch one or more areas of display 202. Display 202 may display video, image, and/or text information. For example, display 202 may display a set of mobile application icons 220. A mobile application icon 220 may be a representative image of the underlying mobile application. For example, a car racing game mobile application may be represented by an image of a car riding on a track. In another example, an animal hunting game mobile application may be represented by a moose being aimed at by a rifle. A mobile application icon may have a predetermined shape (e.g., square) and/or a predetermined resolution (e.g., measured by pixel count). As used herein, when referring to a mobile application that is being displayed on display 202, it should be understood that it is the icon of the mobile application that is being displayed. It is noted that the mobile application includes a collection of complied codes and/or source codes, together with resource information such as multimedia data (e.g., video, image, etc.). For simplicity, however, the term “mobile application” is also used to refer to the icon displayed on mobile device 200, unless otherwise noted.

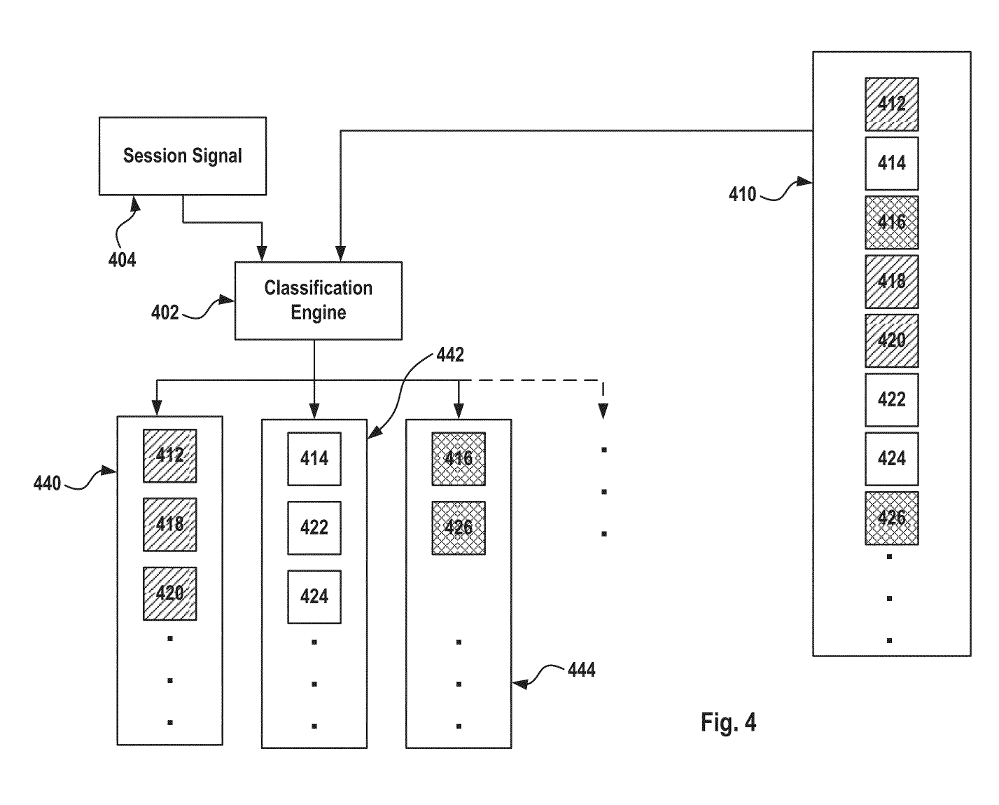

As shown in FIG. 2, the set of mobile applications 220 may be arranged in a grid comprising of rows and columns. Each mobile application within the grid may have relations to the adjacent, nearby, surrounding, and/or neighboring mobile applications. Such relations will be discussed in greater detail with respect to FIGS. 4-8.

As shown in FIG. 2, mobile device 200 may include one or more buttons 204. In one embodiment, buttons 204 may be hard buttons that include physical socket and cover. In another embodiment, buttons 204 may be soft buttons displayed on display 202. In some embodiments, buttons 204 may include both hard and soft buttons. Buttons 204 may be used by a user to select, deselect, and/or navigate content displayed on display 202. Mobile device 200 may include one or more cameras 208. Camera 208 may be located on the front and/or back face of mobile device 200. Mobile device 200 may include a power switch 206. Power switch 206 may be located on the front face, back face, or along the edges of mobile device 200. Mobile device 200 may include a wireless communication module 210. Communication module 210 may include hardware devices such as one or more antennas, modulators, encoders, decoders, etc., as well as software to communicatively connect mobile device 200 to network 130 via, for example, WLAN/WiFi, 3G, 4G, LTE, Bluetooth, etc.

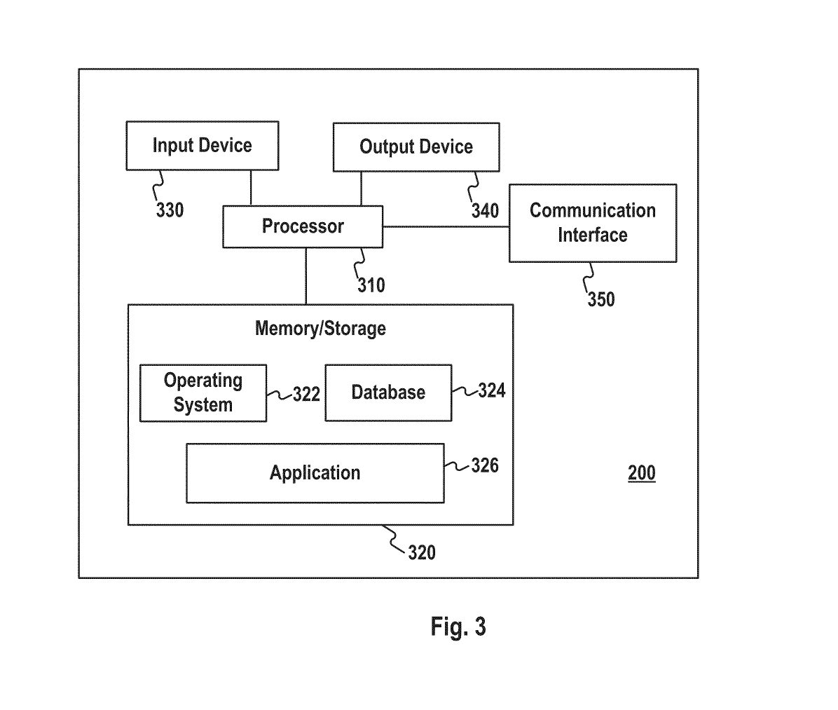

FIG. 3 is a block diagram of the exemplary mobile device 200 shown in FIG. 2. Consistent with some embodiments, mobile device 200 may include a processor device 310, a memory/storage module 320, an input device 330, an output device 340, and a communication interface 350. Processor device 310 may be a central processing unit (“CPU”) or a mobile processor. Depending on the type of hardware being used, processor device 310 can include one or more ICs, PCBs, and/or microprocessor chips. Processor device 310 can execute computer program instructions to perform various methods, operations, and/or tasks that will be explained in greater detail below.

Memory/storage module 320 may include, for example, a RAM, a ROM, a flash memory, a SSD, or other suitable temporary or permanent data storing devices. In some embodiments, computer program instructions can be stored, accessed, and read from the ROM, flash memory, SSD, or any other suitable memory location, and loaded into the RAM for execution by processor 310. For example, memory/storage module 320 may store an operating system 322, one or more software applications including mobile applications 326, and a database 324.

In some embodiments, software application 326 or portions of it may be stored on a computer readable medium, such as a hard drive, optical disk, flash drive, SD card, memory stick, or any other suitable medium, and can be read and acted upon by processor 310 using routines that have been loaded to memory/storage module 320.

In some embodiments, input device 330 and output device 340 may be coupled to processor 310 through appropriate interfacing circuitry. In some embodiments, input device 330 may include a hardware keyboard, a keypad, a touch screen, etc., through which a user may input information to mobile device 200. Input device 330 may also include camera 208 and buttons 204 shown in FIG. 2. Output device 340 may include one or more display screens, such as display 202.

Communication interface 350 may provide communication connections such that mobile device 200 may exchange data with external devices. For example, mobile device 200 may be connected to network 130 through communication interface 350. Communication interface 350 may include, for example, communication module 210 shown in FIG. 2.

Consistent with some embodiments, mobile device 200 may be configured to present mobile applications to a user based on their similarities. For example, mobile device 200 may execute a mobile application to perform the operations of presenting or showing similar mobile applications. Similar mobile applications may be organized in one or more groups through a grouping process. In some embodiments, the grouping of mobile applications may be performed by mobile device 200. In these embodiments, mobile device 200 may collect a set of mobile applications or information relating to the set of mobile applications, and execute a grouping method to classify the set of mobile applications based on their similarities using local computing resources such as processor 310 and memory/storage module 320. In other embodiments, the grouping of mobile applications may be performed by server 150 (e.g., using processor 152 and memory/storage 154). The grouped mobile applications, or information related thereto, may then be downloaded by mobile device 200 through network 130. In other embodiments, the grouping of mobile applications may be performed jointly by both mobile device 200 and server 150. For example, mobile device 200 may obtain information of a set of mobile applications based on user operations, and may send the information to server 150 for grouping. After server 150 groups the mobile applications, server 150 may send the grouping results back to mobile device for presenting to the user.

FIG. 4 is a schematic diagram illustrating an exemplary method for grouping mobile applications, according to some embodiments of the present disclosure. As described above, grouping of mobile applications can be performed by mobile device 200, server 150, or a combination thereof. Referring to FIG. 4, a classification engine 402 may be provided to group mobile applications. Classification engine 402 may be in the form of a hardware device, a software program, or a combination thereof. For example, classification engine 402 may be implemented as a standalone hardware device located in server 150 or mobile device 200. In another example, classification engine 402 may be implemented as a software program executable by processor 152 of server 150, processor 310 of mobile device 200, or both.

In some embodiments, classification engine 402 may receive, as an input, a set of mobile applications or information thereof from a mobile application pool 410. Mobile application pool 410 may include one or more mobile application stores, a collection of mobile applications based on certain criteria (e.g., a collection of mobile applications that are deemed similar by certain mobile application stores, mobile application recommendation software, and/or mobile application platforms); a set of mobile applications selected or otherwise related to one or more users, or any other collections including a plurality of mobile applications. The mobile applications in mobile application pool 410 may relate to different subject matter. For example, mobile application pool 410 may include a plurality of games (e.g., 412, 414, 416, 418, 420, 422, 424, and 426). Among the games, 412, 418, and 420 may be racing games; 414, 422, and 424 may be shooting games; and 416 and 426 may be pet raising games. Each mobile application may have certain associated properties or parameters, including the title or name of the mobile application, description of the mobile application, rating of the mobile application, etc.

In some embodiments, classification engine 402 may receive, as an additional input, session signal 404 from mobile device 200. Session signal may include, for example, information relating to the user of mobile device 200, such as age, gender, residence, education, income, history of purchase (e.g., purchase of mobile applications from one or more application stores), monthly expense on mobile applications, etc. Session signal may also include information relating to the operation and configuration of mobile device 200, such as key stroke history, browsing history, time spent on one or more mobile applications, list of mobile applications installed on mobile device 200, etc. Session signal may be obtained by a mobile application installed on mobile device 200 through accessing, for example, system level configuration file, use profile, buffer file, online information, information stored in the cloud, etc.

Classification engine 402 may classify the set of mobile applications into one or more groups (e.g., groups 440, 442, 444) based on the properties/parameters associated with the mobile applications, and optionally also based on session signal 404. For example, classification engine 402 may compute a metric or a distance function indicating a distance between mobile applications in the set of mobile applications input to classification engine 402. The distance between two mobile applications may indicate the similarity between the two mobile applications. The metric or distance function may be determined using machine learning technique, taking into consideration objective measures, such as factors related to the mobile applications (title, description, rating, icon image, screenshot pictures, similarity scores determined by certain mobile application stores/software/platforms, etc.), and optionally subjective measures, such as factors related to the user (e.g., session signal 404). This is because the similarity between two mobile applications, from a particular user's point of view, can be affected by both objective measures (how similar to a general user) as well as subjective measures (how similar to this particular user).

In some embodiments, the distance function or metric between two mobile applications may be computed using a Euclidean metric/distance, a string similarity metric (or string distance function), or a combination thereof. A Euclidean distance can be determined by calculating the distance between two points in a Euclidean space. For example, a distance d(p, q) between two points p(p₁, p₂, . . . , pₙ) and q(q₁, q₂, . . . , qₙ) in Cartesian coordinates is given by d(p, q)=sqrt((p₁−q₁)²+(p₂−q₂)²+ . . . +(pₙ−qₙ)²). Euclidean distance may be used to measure similarity between two numerical values, such as the ratings, or other parameters that can be converted into numbers. A string metric or string distance function is a metric that measures similarity between two text strings. One example is Levenshtein Distance (also known as Edit Distance), which calculate minimal number of insertions, deletions, and/or replacements needed for transforming string a into string b. The title, description, or other text-based parameters may be measured using string metric/distance function. The string metric can provide a numerical value indicating the distance (e.g., indicating the similarity) between two strings. Although the disclosure provides some examples of numerical distance and string distance functions, a person having ordinary skill in the art should appreciate that other functions or algorithms can be used. For example, other string similarity functions may include Damerau-Lavenshtein distance (which is similar to Levenshtein distance, but transposition of adjacent symbols is allowed), q-gram distance, etc.

The distance between two mobile applications may be a weighted combination of two or more kinds of metrics (e.g., Euclidean metric, string metric, etc.). The weighting factors associated with each individual distance/metric may be predetermined or dynamically adjusted, depending on particular embodiments. In some embodiments, each parameter may be assigned a weight. For example, title may be assigned with a weight that is bigger than other parameters.

With the metric or distance function, classification engine 402 may then classify mobile applications into one or more groups. In one embodiment, classification engine 402 may start from a seed mobile application, and collect a set of mobile applications that are close to the seed mobile application based on the metric/distance function. For example, classification engine 402 may start from mobile application 412, and determine that mobile applications 418 and 420 are close to mobile application 412 based on the metric/distance function. To determine the closeness, classification engine 402 may compare the distance between mobile application 412 and each of mobile applications 414, 416, 418, 420, etc. If the distance is less than a threshold, then the mobile application to which the distance is compared can be deemed as being close to, and therefore similar to, mobile application 412. In this way, mobile applications similar to mobile application 412 may be classified and grouped into mobile application group 440. Classification engine 402 may then move on to determine mobile applications that are similar to mobile application 414, and group those mobile applications into mobile application group 442. Similarly, mobile applications similar to mobile application 416 can be classified and grouped into mobile application group 444. This classification and grouping process may continue until all or a certain number of mobile applications in mobile application pool 410 are grouped.

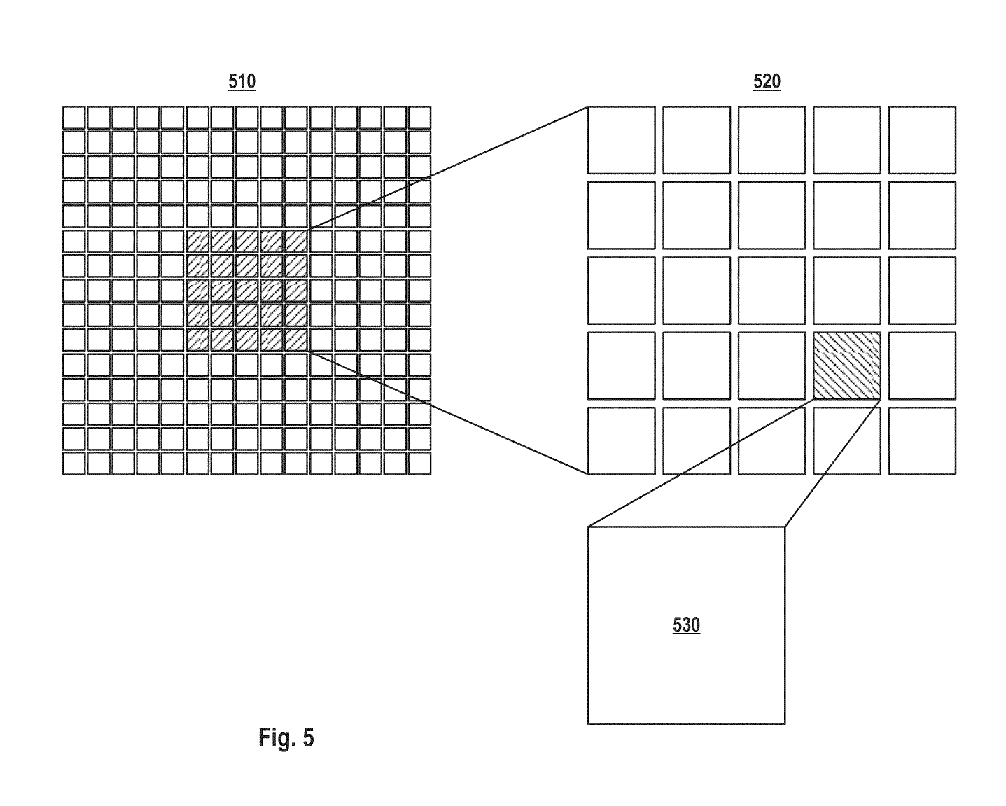

Once mobile applications are grouped, the grouped mobile applications may be displayed to a user so that the user may view, explore, and/or select one or more mobile applications. FIG. 5 is schematic diagram illustrating an exemplary method for displaying mobile applications, according to some embodiments of the present disclosure. As shown in FIG. 5, view 510 may be displayed on display 202 to show a relatively large number of mobile applications. In view 510, each small square represents a mobile application, and the mobile applications are arranged in a grid format including rows and columns. View 510 may be zoomed in or zoomed out. For example, the user may operate on display 202 (e.g., when display 202 is a touch screen) or press one or more buttons 204 to zoom in/out view 510. When view 510 is zoomed out, the size of each mobile application may become smaller and more mobile applications may enter into the view. When view 510 is zoomed in, each mobile application may become larger and less mobile applications may remain in the view. For example, view 520 is an example of a zoomed-in view of view 510. The user may also pan and/or rotate view 510. When the user pans view 510, the entire view may move along a linear direction. When the user rotates view 510, the entire view may move along a circular direction. In one embodiment, the entire set of mobile applications may be arranged on a planner surface such that the view has edges in both horizontal and vertical directions. In this case, the user may not be able to pan/rotate the view beyond the edges. In another embodiment, the entire set of mobile applications may be arranged on a cylindrical surface such that one of the horizontal and vertical directions is edgeless. In another embodiment, the entire set of mobile applications may be arranged on a spherical surface such that both horizontal and vertical directions are edgeless.

View 510 may include any number of mobile applications. In one embodiment, view 510 may include 10000 mobile applications arranged in a 100×100 grid. In other embodiments, view 510 may include 1000, 100, or other quantities of mobile applications.

Mobile applications arranged in the grid format (e.g., as shown in view 510) may be arranged into regions or areas according to their similarities. For example, mobile applications 412, 418, and 420 (e.g., all are racing games) in mobile application group 440 may be placed, together with other similar mobile applications, in the shadowed area of view 510. A user, interested in racing games, may select or zoom in into the shadowed area of view 510, to obtain view 520 on display 202. Compared to view 510, view 520 may provide higher resolution icons, more detailed mobile application information such as title, rating, etc. The user may further select or zoom in into a particular mobile application, to obtain view 530. View 530 may provide even more detailed information about the mobile application, such as introduction, version history, user reviews, pricing, button to download or purchase, etc. In some embodiments, the transition from view 510 to view 520 and further to view 530 may be made continuous to create a seamless zooming experience. While the view is zooming in, more detailed information may gradually appear to commensurate with the size and density of the mobile applications.

Displaying mobile applications in a 2D grid, such as view 510, may provide several advantages over the traditional methods of displaying the mobile applications in a row or a column. First, the field of view can be greatly expanded. Instead of displaying less than 10 mobile applications per page/screen, the 2D grid may display hundreds or even thousands of mobile applications on a single page or screen. Second, on a 2D grid, similar mobile applications can be grouped together into clusters. When a user is browsing mobile applications of a particular subject matter, the user may see a collection of mobile applications relating to that subject matter grouped into a compact region within the 2D grid (also referred to as a cluster). For example, the shadowed region of view 510 may form a cluster. Third, different clusters may be arranged in the 2D grid in a way such that the distance between clusters is related to the similarity of the subject matter of the clusters. In this way, when a user is browsing mobile applications in one cluster, the user may likely to navigate to the neighboring clusters because the user may also be interested in the similar subject matter of the neighboring clusters. Mobile applications matching the user's interest may be seamlessly inserted into the 2D grid based on such arrangement.

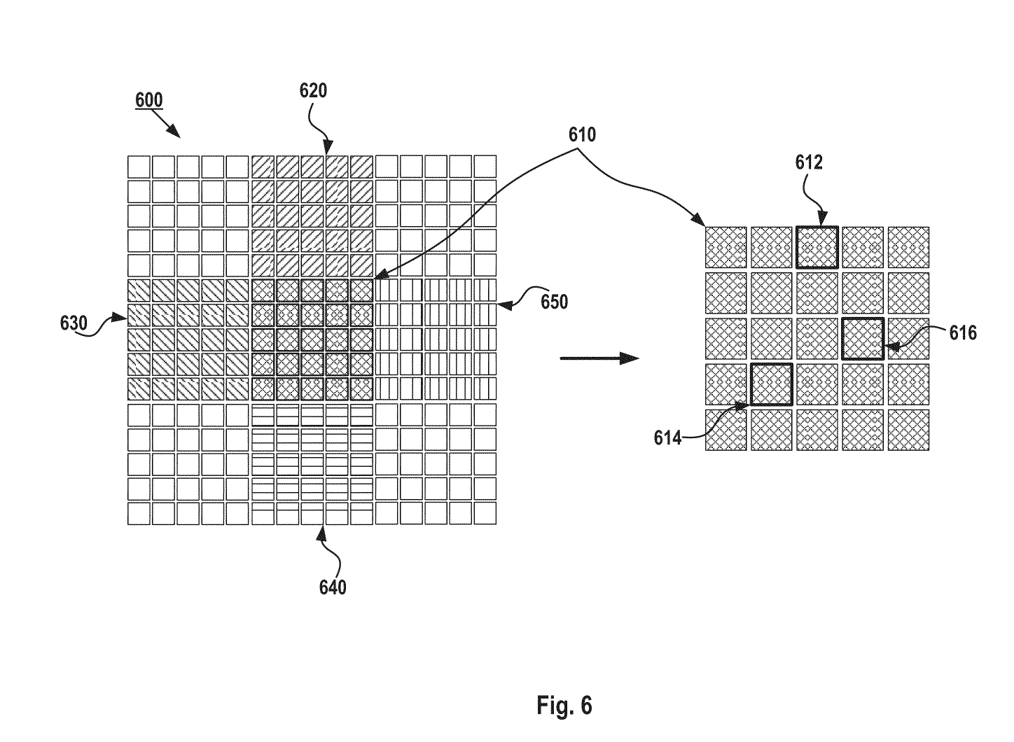

FIG. 6 is a schematic diagram illustrating an exemplary method for inserting mobile applications in a cluster that has similar applications, according to some embodiments of the present disclosure. Referring to FIG. 6, a plurality of mobile applications may be arranged in a 2D grid 600. Grid 600 may include one or more clusters, such as clusters 610, 620, 630, 640, and 650. While the clusters shown in FIG. 6 all have 25 mobile applications arranged in a 5×5 square, this is for illustration purpose only. A cluster may include any number of mobile applications arranged in any shape. Each cluster may include similar mobile applications. Clusters may also be arranged based on their similarities. For example, the degree of similarity between cluster 620 and cluster 610 may be higher than the degree of similarity between cluster 620 and cluster 640. Base on the structure of grid 600, a user's interest may be detected. For example, when a user spends a relatively long time (e.g., longer than a predetermined threshold) on a particular portion of the grid (e.g., a displayed view of mobile applications), the user may likely be interested in the subject matter/theme/topic contained in that particular portion. In another example, when a user navigates through a series of mobile applications, the sequence of navigation actions (e.g., zooming, panning, selecting, clicking, etc.) may reveal the user's interest. Because the structure of grid 600 is associated with the subject matter of the mobile applications or clusters, processor 152/310 may determine the user's interest or taste based on the user's behavior with respect to grid 600. Based on the detected user interest, processor 152/310 may insert mobile applications (e.g., recommendations) in the cluster that matches the user's interests. For example, referring to FIG. 6, within cluster 610, mobile applications 612, 614, and 616 may be inserted into proper locations. In some embodiments, mobile applications 612, 614, and/or 616 may not be among the mobile applications that are originally grouped into cluster 610. Rather, mobile applications 612, 614, and/or 616 may be chosen/selected/determined by processor 152/310 based on user's behavior and inserted into cluster 610. In some embodiments, one or more inserted mobile applications may replace the original mobile application(s) that are located in a cluster. In some embodiments, one or more mobile applications may be dynamically inserted into a cluster based on user interest detection. In some embodiments, one or more mobile applications may be periodically inserted into a cluster based on subject matter.

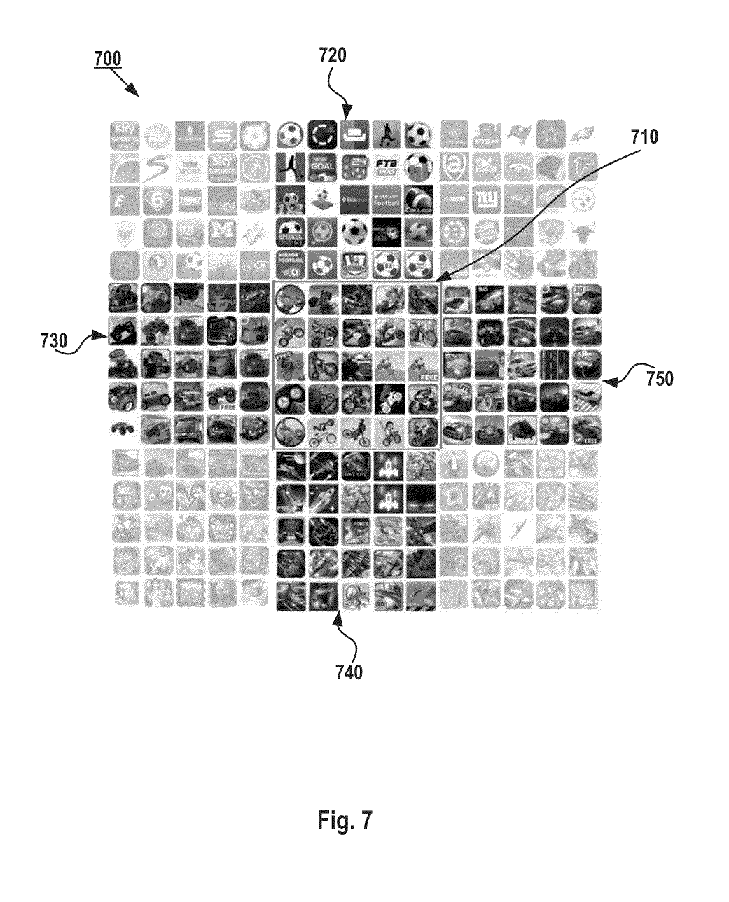

FIG. 7 illustrates an exemplary two-dimensional graph of grouped mobile applications, according to some embodiments of the present disclosure. As shown in FIG. 7, 2D grid view 700 may include mobile application grouped in clusters based on their similarities. For example, cluster 710 may include motorcycle racing games, cluster 720 may include soccer games, cluster 730 may include truck racing games, cluster 740 may include flight shooting games, and cluster 750 may include car racing games. With the arrangement shown in grid 700, a user browsing motorcycle games in cluster 710 may also be interested in car racing games and truck racing games, which are placed next to cluster 710. The user may easily navigate to car racing games or truck racing games from cluster 710. In another example, the user interested in motorcycle games may be interested in sports games such as soccer games, or action games such as flight shooting games. By placing these types of games next to or close to cluster 710 and detect whether the user navigates to and spends time on these games, the user's interest may be further understood and personalized mobile application recommendation may be implemented.

In some embodiments, mobile application clusters may be in any shape, including regular (e.g., square, rectangular, etc.) or irregular shapes, and new mobile applications may be embedding into a cluster dynamically. Embedding mobile applications into clusters to form a 2D grid may also be referred to as a cluster growing and grid growing process. For example, embedding mobile applications can be implemented by grouping similar mobile applications into clusters and placing the clusters in a 2D space where the distance between clusters simulates the similarity of the clusters. In another example, clusters may be folded into a 2D space by a continuous area growth method with geometric and spatial constrains.

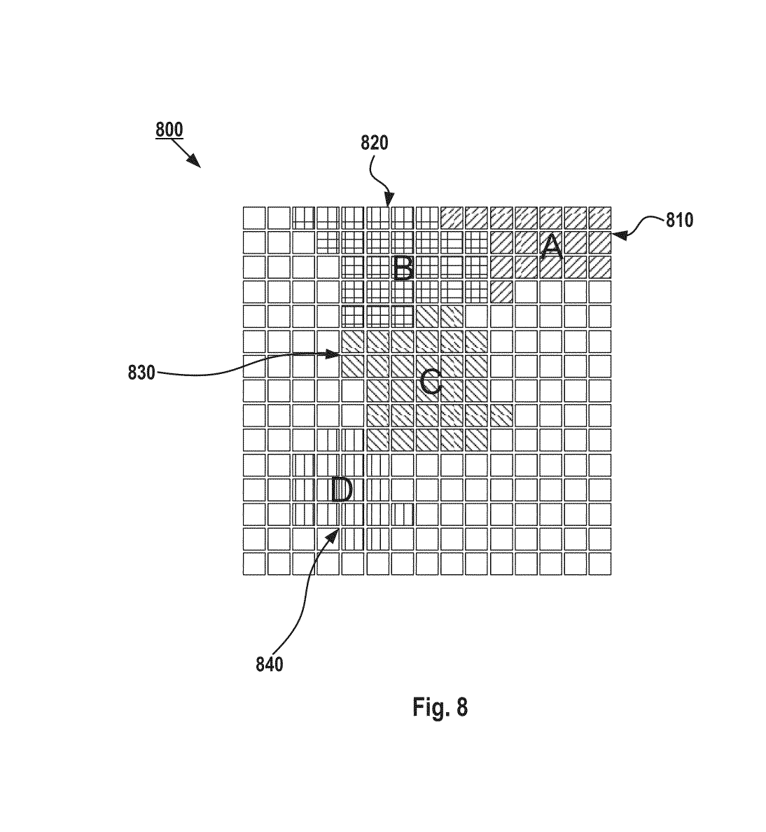

FIG. 8 is a schematic diagram illustrating an exemplary method for embedding mobile applications, according to some embodiments of the present disclosure. In FIG. 8, 2D grid 800 may include clusters A (810), B (820), C (830), and D (840). Each cluster may be related to a subject matter and contain similar mobile applications with respect to the subject matter. Each cluster may occupy a continuous, non-breaking area. Processor 152 or 310 may determine the distance between clusters A, B, C, and D, based on the similarity of their subject matter. In some embodiments, processor 152/310 may compute an individual distance between two mobile applications, each residing within a different cluster. For example, a distance between a first mobile application in cluster A and a second mobile application in cluster B may be computed using, for example, the distance function/metric method discussed earlier with respect to FIG. 4. Similarly, processor 152/310 may compute an individual distance for each pair of mobile applications between clusters A and B. For example, in FIG. 8, cluster A has 18 mobile applications and cluster B has 28 mobile applications. Therefore, 18*28=504 individual distances may be computed. The distance between clusters A and B, accordingly, may be determined to be an average of all individual distances. In some embodiments, a weighted average may be used to indicate the distance between two clusters, where the weighting factors may be determined based on, for example, the individual distance values, the size of the clusters involve, the kind of mobile applications, the subject matter, etc. Based on the distance between clusters, these clusters may be placed in grid 800 to simulate the respective distance between one another. For example, in FIG. 8, the distance between cluster A and C is smaller than the distance between clusters A and D, indicating cluster A is more similar to C than D. Because each cluster may contain different number of mobile applications, the exact shape of each cluster may be irregular to accommodate constrains imposed by neighboring clusters.

Based on the structure of a 2D grid, virtual communities or neighborhoods may be formed. For example, when a plurality of users use the grid to explore, navigate, select, and/or download mobile applications, the users' interests and tastes may be collected and analyzed. The interests/tastes may be mapped to the grid where users with similar interests/tastes may be grouped together to form virtual communities or neighborhoods.

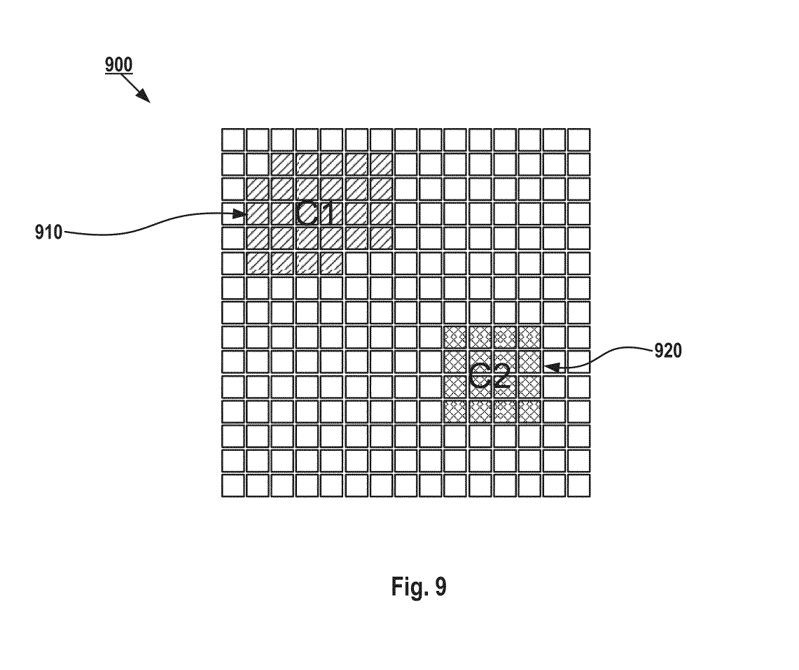

FIG. 9 is a schematic diagram illustrating exemplary virtual communities, according to some embodiments of the present disclosure. In FIG. 9, grid 900 may include virtual communities C1 (910) and C2 (920). Virtual communities C1 and C2 may be formed by grouping users having or showing interests to mobile applications within one or more clusters. For example, virtual community C1 may be based on multiple similar clusters sharing a common subject matter, such as racing games including car racing, motorcycle racing, truck racing, etc. Virtual community C2 may be based on a single cluster, such as zombie games. Users using or otherwise showing sufficient interests to mobile application within the virtual community boundary may be invited to join the virtual community and be connected to other users having similar interests or tastes.

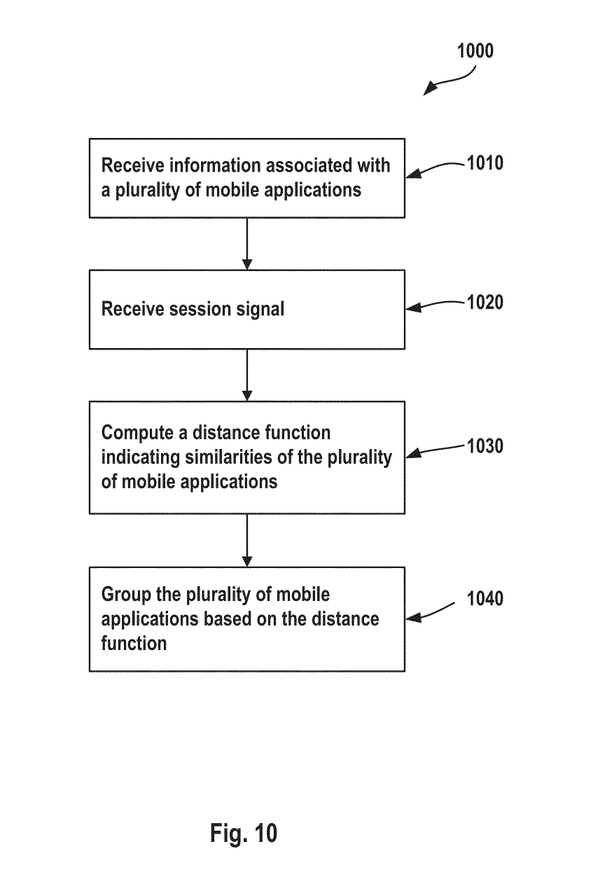

FIG. 10 is a flow chart of an exemplary method 1000 for grouping mobile applications, according to some embodiments of the present disclosure. In step 1010, classification engine 402 (e.g., implemented by processor 152 or 310) may receive information associated with a plurality of mobile applications from a mobile application pool 410. In step 1020, classification engine 402 may receive session signal 404. In step 1030, classification engine 402 may compute a distance function based on the received plurality of mobile applications and/or session signal. The distance function may indicate similarities of the plurality of mobile applications. In step 1040, classification engine 402 may group the plurality of mobile applications based on the distance function.

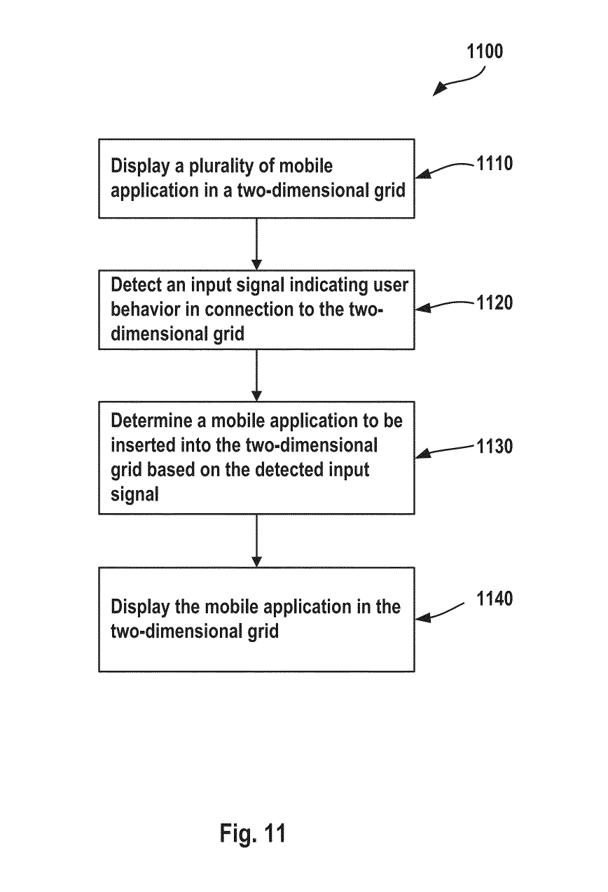

FIG. 11 is a flow chart of an exemplary method 1100 for inserting mobile applications, according to some embodiments of the present disclosure. In step 1110, processor 310 may control output device 340 to display a plurality of mobile applications in a two-dimensional grid, such as grid 600. The two-dimensional grid may include one or more clusters each containing a group of similar mobile applications. In step 1120, processor 310 may detect, through input device 330, an input signal indicating user behavior in connection to the two-dimensional grid. For example, the input signal may include the time duration a user spends on viewing a particular cluster or a portion of the two-dimensional grid, mouse click events, finger/stylus movements, browsing/navigation history, etc. In step 1130, processor 310 or processor 152 may determine a mobile application (e.g., mobile application 612, 614, or 616) to be inserted into the two-dimensional grid based on the detected input signal. In step 1140, processor 310 may control output device 340 to display the inserted mobile application in the two-dimensional grid to the user.

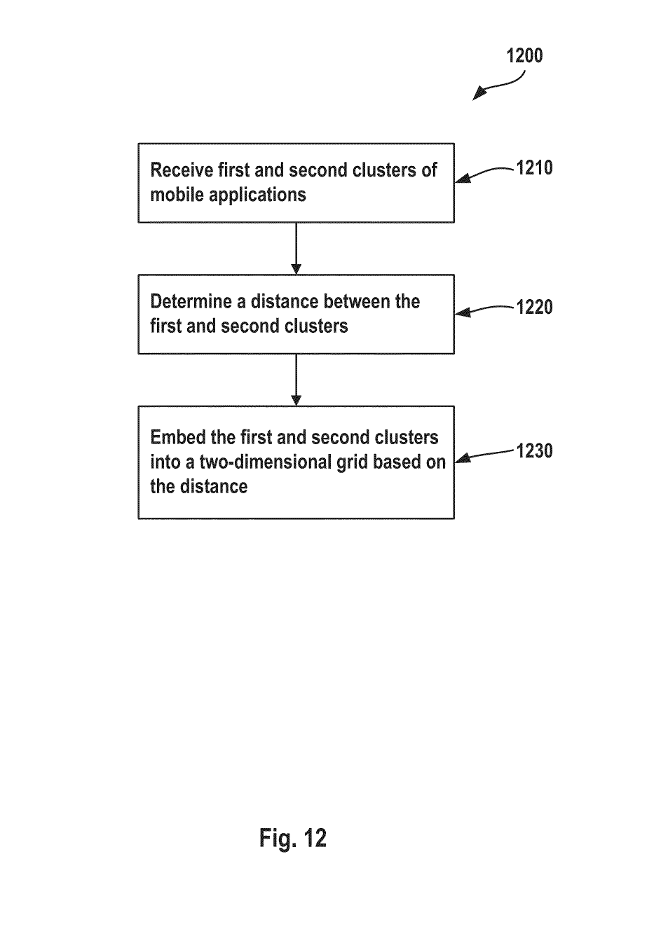

FIG. 12 is a flow chart of an exemplary method 1200 for embedding mobile applications, according to some embodiments of the present disclosure. In step 1210, processor 310 or 152 may receive first and second clusters of mobile applications (e.g., clusters 810 and 830). Each cluster may include similar mobile applications sharing a common subject matter. In step 1220, processor 310 or 152 may determine a distance between the first and second clusters (e.g., a distance between clusters 810 and 830) based on the degree of similarity between the two clusters. In step 1230, processor 310 or 152 may embed the first and second clusters into a two-dimensional grid (e.g., grid 800) based on the distance. For example, clusters 810 and 830 may be placed in regions of grid 800 such that the distance between cluster 810 and 830 simulates the degree of similarities between the two clusters. In addition, mobile applications within each cluster may be arranged using a continuous growth method to comply with the geometric and spatial constrains of the two-dimensional grid, such as existing clusters, clusters to be added together with the first and second clusters, boundary constrains of the two-dimensional grid, reserved space (e.g., for promotional mobile applications), etc.

The specification has described systems and methods for organizing mobile applications. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method, implemented by a processor device, for grouping mobile applications, the method comprising:
receiving information associated with a plurality of mobile applications;
computing, by the processor device, a distance function indicating similarities of the plurality of mobile applications; and
grouping the plurality of mobile applications based on the distance function.

2. The method of claim 1, comprising:
receiving a session signal from a mobile device, the session signal including at least one of:
information relating to a user of the mobile device; or
information relating to operation or configuration of the mobile device.

3. The method of claim 2, comprising:
computing the distance function based on the session signal.

4. The method of claim 1, comprising:
computing the distance function based on parameters associated with the plurality of mobile applications.

5. The method of claim 4, wherein the parameters associated with the plurality of mobile applications include numerical values, and the method comprises:
computing the distance function based on a Euclidean distance associated with the numerical values.

6. The method of claim 4, wherein the parameters associated with the plurality of mobile applications include text strings, and the method comprises:
computing the distance function based on a Levenshtein distance associated with the text strings.

7. A method, implemented by a processor device, for organizing mobile applications, the method comprising:
controlling a display device to display a plurality of mobile applications in a two-dimensional grid;
detecting, using an input device, an input signal indicating user behavior in connection to the two-dimensional grid;
determining, by the processor device, a mobile application to be inserted into the two-dimensional grid based on the detected input signal; and
controlling the display device to display the inserted mobile application in the two-dimensional grid.

8. The method of claim 7, wherein the plurality of mobile applications in the two-dimensional grid are arranged on a planner, cylindrical, or spherical surface.

9. The method of claim 7, wherein a quantity of the plurality of mobile applications is more than 100.

10. The method of claim 7, wherein the plurality of mobile applications in the two-dimensional grid are arranged into regions according to similarities of the plurality of mobile applications.

11. The method of claim 10, wherein detecting the input signal indicating user behavior in connection to the two-dimensional grid includes:
detecting the input signal based on a user selection of one or more mobile applications arranged in a particular region.

12. The method of claim 7, comprising:
determining user interest based on the detected input signal; and
determining the mobile application to be inserted into the two-dimensional grid based on the user interest.

13. The method of claim 7, wherein controlling the display device to display the inserted mobile application in the two-dimensional grid comprising:
replacing an original mobile application in the two-dimensional grid with the inserted mobile application.

14. A method, implemented by a processor device, for embedding mobile applications into a two-dimensional grid, the method comprising:
receiving first and second clusters of mobile applications;
determining, by the processor device, a distance between the first and second clusters based on similarities between the first and second clusters; and
embedding, by the processor device, the first and second clusters into the two-dimensional grid based on the distance.

15. The method of claim 14, wherein determining the distance between the first and second clusters comprises:
determining an individual distance between each pair of mobile applications in the first and second clusters; and
determining the distance between the first and second clusters based on an weighted average of all individual distances.

16. The method of claim 15, comprising:
determining weighting factors for calculating the weighted average based on at least one of:
the individual distances;
sizes of the first and second clusters;
kinds of the mobile applications included in the first or second clusters; or
subject matter of the mobile applications included in the first or second clusters.

17. The method of claim 14, comprising:
embedding a plurality of clusters into the two-dimensional grid such that distances among the plurality of clusters in the two-dimensional grid approximate similarities among the plurality of clusters.

18. The method of claim 17, comprising:
forming a virtual community based on neighboring clusters in the two-dimensional grid.
